(19) United States
(12) Patent Application Publication
(10) Pub. No.: US 2009/0100031 A1
(43) Pub. Date: Apr. 16, 2009

(54) Method and System for Detecting Changes in Geographic Information

(75) Inventors: Thomas William Gilligan, Lebanon, NH (US); Patrick Allan McDevitt, Braine-l'Alleud (BE); George T. Angwin, Wilder, VT (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/121,643

(22) Filed: May 15, 2008

Related U.S. Application Data
(60) Provisional application No. 60/979,700, filed on Oct. 12, 2007.

(51) Int. Cl. G06F 7/06; G06F 17/30

(52) U.S. Cl. 707/4; 707/E17.018; 707/E17.014; 707/E17.108

(57) ABSTRACT

Data related to changes in real-world geography are collected promptly for incorporating into a geographic database. Query strings are created using keywords targeted to detect data related to changes in real-world geography. Automatic Web search technology is utilized to search the World Wide Web for instances that match the created query strings. References to Web pages, references to Web pages accompanied by brief abstracts, Web pages, and hard copies of documents by mail are automatically collected that potentially refer to changes in real-world geography.

### CLAIM OF PRIORITY

This application claims priority to U.S. Provisional Patent Application 60/979,700 filed Oct. 12, 2007, entitled “METHOD AND SYSTEM FOR DETECTING CHANGES IN GEOGRAPHIC INFORMATION,” which is hereby incorporated by reference.

### BACKGROUND OF THE INVENTION

1. Field of the Invention

The present invention relates to geographic database information and, more particularly, to the collection and storage of geographic database information.

2. Description of the Related Art

Digital maps are used in many consumer products to enable end-users to locate places on the digital maps and assist end-users in finding directions to a place. Places include street addresses, buildings located at street addresses such as businesses and landmarks, and facilities such as shopping malls and business parks. These consumer products are devices and systems in the form of in-vehicle navigation systems that enable drivers to navigate over streets and roads, hand-held devices such as personal digital assistants (“PDAs”), personal navigation devices, and cell phones that can do the same, and Internet applications in which users can generate maps showing desired places. The common aspect in all of these and other types of devices and systems is a geographic database of geographic features and software to access and manipulate the geographic database in response to user inputs. Essentially, in all of these devices and systems, a user can enter a desired place and the returned result will be the position of that place. Typically, users will enter the names of a business, a destination landmark, or a street address, and then be returned the location of the requested place. The location can be shown on a map display, or can be used to calculate and display a route and/or driving directions to the location, or used in other ways.

Digital maps are also used in Geographic Information System (GIS) applications, where a GIS is a system for capturing, storing, analyzing, and managing data and associated attributes which are spatially referenced to the earth. For example, a digital map can be used as a base map in a GIS application that manages geographically distributed facilities, such as an electric utility's poles, transformers, and substations. In another example, a digital map can be used in a GIS application that sets flood insurance rates based on the location of a building and government defined flood zones. Additionally, a digital map can be used with a GIS application to provide a vehicle equipped with a GPS receiver with prompt recovery after theft and with emergency services. In another example, a digital map can be used in a GIS application to analyze where to place businesses based on geography and census data. In a final example, a digital map can be used with a GIS application to provide people seeking to buy real estate with maps that show the locations of potential properties and of nearby places that are relevant to the properties' values, such as schools and hospitals.

In applications for the devices and systems described above, digital maps must be up to date in order to achieve superior results for the end-users of these devices and systems. A digital map is stored in a geographic database. A geographic database also stores associated data of the digital map including, but not limited to, tables of location reference codes, images, lists of points of interest, and map legend information. A digital map includes features that represent real-world objects, such as a road segment, a roundabout, a city, and a bridge, among others. A feature can carry attributes that describe the feature. For example, the list of potential attributes for a road segment is quite long and includes such attributes as road class, pavement type, direction of traffic flow, and street name, among others. One problem is that the real-world features that are stored as information in the digital map are constantly in change. Changes to the geographic databases require detection of the changes in the real world and inclusion of the changes in the geographic databases. Changes in geographic database information include street network changes, street name changes, new addresses, and changes in addresses, among others. These changes also include changes in vehicle routing attributes and navigation attributes. Vehicle routing attributes involve traffic flow patterns on the streets, such as lane structures, turn restrictions, and one-way streets, among others. Navigation attributes include but are not limited to, speed limits, transit times, height and weight restrictions, axle restrictions, hours of operation and vehicle type restrictions.

For one current change detection method, a geographic database producer sends field survey teams that physically go out to real-world locations to find new and changed real-world geographic information. Other current change detection methods include aerial and satellite photography. These methods can give good information regarding the existence and geometry of new or changed roads, but they have little direct value regarding attributes such as street names and addresses. Additionally, these methods are expensive, and their coverage is spotty and irregular.

Other current change detection methods use a U.S. Postal Service (USPS) ZIP+4 product monthly change file, as well as reports from government bodies responsible for infrastructure. Both the USPS and the government bodies detect geometric street and address changes and can create these reports from this information. The USPS reports are available from the U.S. Postal Service on a monthly basis and allow the geographic database producer to compare the street and address information contained in these reports to the information listed in the database for the same jurisdiction. Any discrepancies between the two reports show where real-world change has taken place. Although the USPS reports are effective in showing new streets, these USPS reports do not show the addition or subtraction of a one way driving restriction on a street or prohibited turn, for example. For the reports from government bodies, the geographic database producer makes arrangements with government bodies responsible for infrastructure to have change information sent automatically when it is recorded. These reports sometimes arrive on a predetermined schedule in the form of plat maps showing the locations and names of new streets and addresses. A plat map is a map showing the location, tax identifier, and dimensions for each land parcel. Little or no vehicle routing or navigation attribution information is included in the plat maps, however. Both types of reports lack speed and efficiency. Further, neither one of these techniques provides detection of changes in vehicle routing and navigation attribution.

It would be beneficial to reduce the cost and improve the speed with which changes in map features and map attributes, as depicted in the real world, are detected and incorporated into the geographic database.

### SUMMARY OF THE INVENTION

Data related to changes in real-world geography are collected promptly for incorporating into a geographic database. Query strings are created using keywords targeted to detect data related to changes in real-world geography. Web search technology is automatically utilized to search the World Wide Web for instances of changes that match the created query strings. References to Web pages are automatically collected that potentially refer to data related to changes in real-world geography. Web pages corresponding to the references are filtered to limit the Web pages to a manageable set of change candidates.

### BRIEF DESCRIPTION OF THE DRAWINGS

Further details of the present invention are explained with the help of the attached drawings in which:

FIG. 1 shows a top-level view of an example flowchart for updating a geographic database, according to embodiments of the present invention;

FIG. 2 shows example sub-steps of step 130 shown in FIG. 1 that collects and filters source material information for update, according to embodiments of the present invention;

FIGS. 3A-3B show an example flowchart of an improved method for gathering source material information and managing overlaps, according to embodiments of the present invention;

FIG. 4 shows example query strings provided to example subscription services, according to embodiments of the present invention;

FIG. 5 shows an example report returned by an example subscription service, according to embodiments of the present invention;

FIG. 6 shows an example Web page and corresponding example content referenced by the first item in the example report of FIG. 5, according to embodiments of the present invention;

FIG. 7 shows an example set of lead tables, according to embodiments of the present invention;

FIG. 8 shows an example table of lead characteristics and requirements used to evaluate leads, according to embodiments of the present invention; and

FIG. 9 shows a block diagram of an exemplary system that can be used with embodiments of the invention.

### DETAILED DESCRIPTION OF THE INVENTION

A method of detecting changes in real-world geographic data close to the time it occurs is provided. Generally, many local government and commercial activities benefit by knowing about such changes. For example, Emergency Services need to know of new street routing. All forms of private and public delivery operations need to know of changes in names and addresses. Sometimes local communities and commercial enterprises post information about such changes at various places on the World Wide Web. A geographic database producer uses query strings that include keywords to search the Web for indications of a change that has been accomplished, is in process, or is proposed. The resulting Web pages are collected, filtered for applicability to the geographic database producer's products, and formed into leads that describe the changes. The leads so collected are then compared with each other and with a library of previously collected leads for references to the same real-world change. Such overlapping leads are combined into one set before going to the next step. The final set of leads is then divided into those which require immediate action and those which describe future changes. A lead describing a future change is tagged with a date at which its status will be reviewed. The geographic database producer's standard update process then consumes leads as production rules require.

Instead of searching the real world for changes to the geographic data, the method uses the speed and broad coverage of the World Wide Web because the Web is large but is also amenable to the power of search engines. Searching the Web using this method produces a more comprehensive list of candidate changes that are compiled much faster and less expensively than alternative processes.

### Geographic Database Production

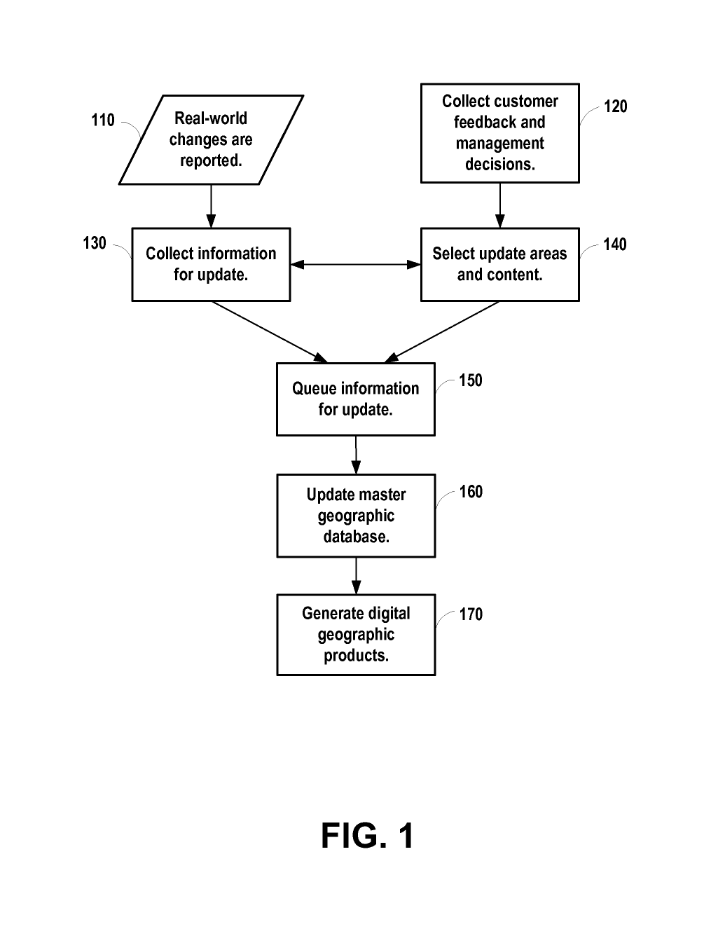

FIG. 1 shows a top-level view of an example flowchart for updating a geographic database, according to embodiments of the present invention. The inputs to this flowchart are changes to the real world that affect the geographic database information, step 110, as well as collected customer feedback and management decisions, step 120. A geographic database producer integrates this information to update its master geographic database, step 160, and generate products for its customers, step 170.

Step 110 represents data corresponding to real-world changes that are reported by people. Someone's knowledge of a change is turned into a document that a geographic database producer can collect and use to drive updating of its master geographic database. The earliest sign of a change in the real-world geography is often the minutes of a city council meeting, a change in 911 addresses for a county, a newspaper article about a forthcoming change, or any other document or report of a change. A geographic database producer can have arrangements with government bodies to be notified of changes, such as 911 address changes. Many changes, however, especially those affecting vehicle navigation and guidance, are first visible to the public in documents that are not easily acquired by a national or international geographic database producer. As the World Wide Web has become more widespread, many of the documents reporting changes in the real world have become available on the World Wide Web. Thus, much of this data becomes accessible to a geographic database producer capable of using the World Wide Web effectively.

The places where these reports can be found are called sources. Sources include, but are not limited to, federal, state, provincial, and local government offices or bodies, companies, such as newspaper companies, commercial organizations, and other organizations.

In step 130, the collection of source material information for update is continuous. Source materials are obtained from many types of sources. Source materials include, but are not limited to, documents, such as those discussed above, that are obtained from many types of sources, whether or not these source materials are found on the World Wide Web. In particular, source materials include, but are not limited to, newspapers, magazine articles, city council minutes, reports by departments of transportation, aerial and satellite photography, national government agency publications, field survey reports, field sensor data, paper maps, paper and electronic documents, data from in-vehicle devices such as navigation devices, sometimes called “floating car data” or “probes,” and customer feedback. For the in-vehicle device data, a probe vehicle is equipped with a special version of a navigation system that is capable of automatically collecting and transmitting data useful for map updating to a central repository. These source materials vary widely in quality, suitability for map production, timeliness, and accuracy, so careful evaluation by the geographic database producer is required before these source materials can be used to update a master geographic database in step 160.

In step 140, the selection of which areas of the geographic database to update with which content, or source material information, is established periodically by the geographic database producer, and then revised as customer needs and business decisions evolve. Examples of such a selection include, but are not limited to, an update of the entire area covered by the master geographic database for a small set of attributes and an update of certain feature types in a specified area. The selection decisions are based partly on what sources are available in step 110, partly on requests by current or prospective customers in step 120, and partly on the business plan for the evolution of the master geographic database in step 120. The business plan may require source material information for additional features or attributes in the master geographic database, so the coordination between step 130 and step 140 is two-way.

In step 150, the information collected in step 130 is queued for updating the master geographic database. The sequencing of the updates is determined by both the availability of source materials from step 130 and the priorities established by step 140. Step 150 is executed frequently to select source material information and place it in queues for incorporation into the master geographic database. Occasionally, a bulk process will be initiated that will select a batch of similar source material information suitable for automatic bulk update.

In step 160, the master geographic database is updated, drawing from the update queue created in step 150. In embodiments, a production team for the geographic database producer performs this update. In step 160, updating of the master geographic database is continuous, driven by a continuous stream of source material information.

In some embodiments, the map update function in step 160 is combined with the collection of source material information in step 130, omitting step 150. These two steps are combined especially when a source is direct observation by field surveyors.

In step 170, periodically, and sometimes on special request, geographic database products are generated from a snapshot of the master geographic database. A product constitutes an entire map, a regional map, or an incremental update. These products are generally delivered to a customer or to a service organization for further transformation into a final product, although some of the products can be ready for the end-users at this stage.

The “time-to-market” is the elapsed time for a change in the real world to become part of a usable geographic database product and depends on the length of each of steps 110, 130, 150, 160, and 170, plus the length of the post-processing required to create an actual end-user product. In current technology, most of the generation of geographic database products in step 170 is automated so this generation consumes the smallest part of the full time-to-market. In addition, much of the update performed in step 160 is assisted by a large amount of automation. For the geographic database producer, the largest part of time-to-market is consumed in step 130 because detecting a change may not take place until some time after it has happened.

### Report Real-World Changes

In step 110, changes to the real-world geographic data are reported. These source materials come in many forms including, but not limited to, paper documents, digital databases, pages in the World Wide Web, and electronic images. As discussed above, these source materials are obtained from many types of sources including, but not limited to, federal, state, provincial, and local government offices or bodies, companies, such as newspaper companies, commercial organizations, and other organizations.

For example, aerial photography can be purchased from the United States Geological Survey (USGS) and from private vendors. Occasionally, the desired photography is commissioned in order to acquire timely and usable images. Aerial photography provides accurate placement and existence for roads, bridges, and water bodies along with the connections between them. In addition, high-resolution photography can provide more details about roads such as the number, placement, and connectivity of lanes. Aerial photography is expensive and therefore not updated very frequently. Consequently, changes captured by aerial photography can take a long time to be detected and find their way into the master geographic database.

In another example, United States Census Bureau TIGER data provides information on the existence of roads, their names, and house number ranges. In the past, TIGER data files did not accurately portray the placement and connectivity of roads. Even today, TIGER data files do not contain details required for vehicle navigation, such as lane structures and turn restrictions. A geographic database producer can receive TIGER updates from the Census Bureau as often as monthly.

Another example is the reports made by field survey teams sent out by the geographic database producer to find new and changed real-world geographic information. Such teams are directed to survey specific areas in search of changes to specific features and their attributes, usually on a predetermined schedule. Sometimes a team is sent to investigate a specific change which some source material information has incompletely defined. Usually a geographic database producer sends these expensive data gathering teams to the more important or fast changing areas frequently while some areas will not be visited as often. Thus, a change in a seldom-visited area can take a relatively long time to come to the attention of a field survey team.

In a further example, the minutes of a city council meeting can contain a decision about a change to a rule for traffic flow, such as to change a pair of parallel streets from two-way traffic to complementary one-way traffic flow. The change can be executed immediately or deferred for weeks or months. These minutes can be summarized in a newspaper article, published on the city's Web site, or published both ways. Such a report can be overlooked by a geographic database producer trying to maintain a national geographic database.

In a yet further example, a newspaper article can report on the resolution of a dispute between the developer of a new subdivision and a neighborhood association over the placement of the access road to the subdivision. For the geographic database producer, this is a signal that the subdivision will soon be built and information on where the access road will connect to the existing road network. The article can be posted on the newspaper's Web site or a reference to the article can be made in the Web site of a real-estate developer trade organization. This is another example of a report that is easily overlooked by the producer of a national geographic database.

A last example is that many state Departments of Transportation maintain Web sites that list road maintenance and new road construction projects that have been proposed, authorized, or are presently underway. These projects are on highways, bridges, and tunnels for which the state is responsible. Such a site gives scheduled starting and completion dates and a summary of the work to be done. Because there are only a few states and provinces, a geographic database producer can monitor these sites to find entries that affect its geographic database, but such monitoring is time consuming and expensive because it is manual and it can be difficult to identify what is new in a Department of Transportation web site.

### Collect Information for Update

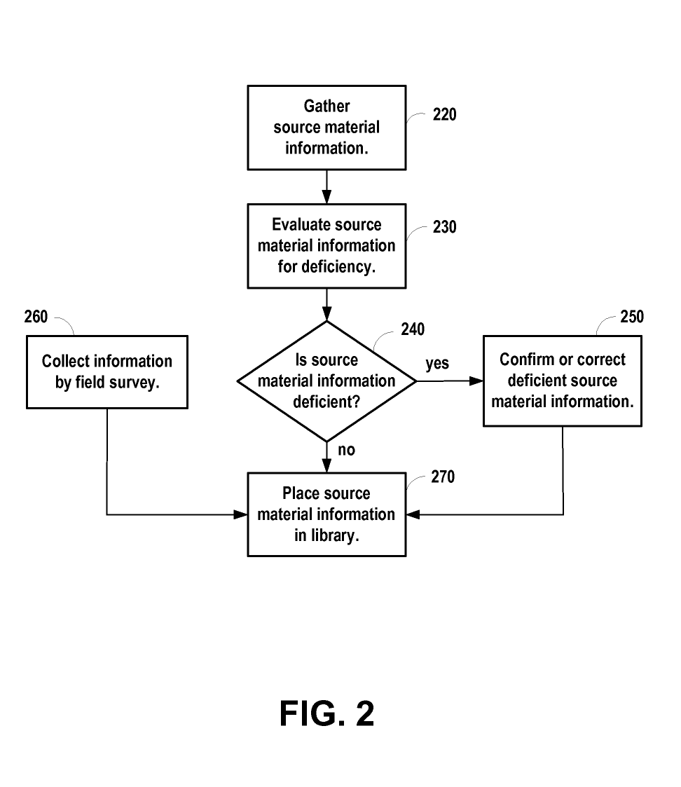

FIG. 2 shows example sub-steps of step 130 shown in FIG. 1 that collects and filters source material information for update, according to embodiments of the present invention. The following description of the sub-steps of step 130 is context for understanding the invention.

The inputs are all the source material information that can be used to update the master geographic database. The outputs are chunks of source material information qualified as ready to use for updating the geographic database. A useful term in describing the filtering process is “deficient” source material information, which lacks one or more of the four properties relevancy, clarity, correctness, and legality. That is, source material information is deficient if it does not describe a change to a feature maintained in the master geographic database, is not clearly presented, or is judged to be questionable or incorrect based on the authority of the source and cartographic judgment. Additionally, source material information is deficient if the change description is copyrighted or if there is an issue of copyright such as, for example, when the right of use for map update has been purchased.

In step 220, source collectors gather source material information for submission to the filtering process beginning in step 230. Data for geographic areas and features that are routinely maintained may sometimes be obtained automatically because the geographic database producer has arranged for routine acquisition. Data for new geographic areas or new features can be specially ordered as required by instructions in step 140, in which update areas and content are selected. If the new areas or features are to become regularly maintained, then arrangements can be made for regular delivery whenever possible. In embodiments, a source collection team for the geographic database producer gathers much of this information. In embodiments, the source collection team submits the source material information to a research team for analysis.

Because of the variable quality and relevance of the source material information gathered in step 220, they are evaluated for deficiency in step 230. Source material information is first checked for relevance. Irrelevant source material information, or that which does not describe changes in features the geographic database producer maintains, are eliminated from further consideration. The remaining relevant source material information is evaluated for clarity, correctness, and legality. In embodiments, the geographic database producer has a research team that performs this evaluation.

An additional task for step 230 is to decide which source material information describes a change event that has already occurred and which describes one scheduled for some future date. If source material information describes a change to the geographic data that has already occurred or is sure to occur before the next release of the geographic database, then it is marked “actionable” so that it will be scheduled for immediate updating of the master geographic database. Otherwise, an attempt is made to discover when the change is scheduled for completion. Based on this information, a date is assigned to the source material information for re-evaluation. Such source material information is marked “monitor” and carries the re-evaluation date.

In step 240, source material information that is not deficient is placed into a library in step 270. Source material information is not deficient if it is relevant, describes a change clearly, appears to be correct, and is legally usable. In step 240, source material information that is deficient undergoes confirmation or correction in step 250.

In step 250, each instance of deficient source material information can either be confirmed as deficient or corrected in one of many ways. The deficient source material information can be compared to information from a second source, if the second source is concerned with the same features at the same location. For example, if the second source material is an official publication, the source material information can be compared to the official publication information to either confirm that the source material information is deficient, or correct the source material information using information from the official publication. A source collector can contact an authority, for example, a government official responsible for the feature, to determine the status of the deficient source material information. The authority can either confirm that the source material information is deficient, or provide corrected source material information. Both of these outcomes are based on the authority's knowledge about the information.

Recent aerial photography of the deficient source material information can be inspected. The source material information can be compared to the aerial photographs or video to either confirm that the source material information is deficient, or correct the source material information using information from the aerial photographs or video. A field survey team can visit the location of the change to determine the status of the deficient source material information. The field survey team can either confirm that the source material information is deficient, or correct the source material information using the information collected at the location of the change.

Finally, users of the geographic database can provide information about the status of deficient source material information. The users may also be contacted to determine the status of the deficient source material information. A user can either confirm that the source material information is deficient, or provide corrected source material information. Both of these outcomes are based on the user's knowledge about the information.

For any of these examples, either the deficient source material information is confirmed by the second source as deficient, or information from the second source is used to correct the deficient source material information. The second source analyzes deficiency by analyzing the four properties of relevancy, clarity, correctness, and legality. In embodiments, this confirmation or correction can be performed by regional research staff located in the particular region in which the change is located. If in step 250 another source confirmed that the deficient source material information was in fact deficient, or if it was not possible to confirm from another source whether the deficient source material information is in fact deficient, the source material information is marked “deficient.” Otherwise, if the deficient source material information can be corrected through information found from a second source, the corrected source material information is marked “corrected” and is accompanied by any corrections discovered in step 250. Whatever the results from the confirmation in step 250, the source material information is placed into a library in step 270.

In step 260, another way to bring source material information into step 130 is presented. In step 260, field survey teams are instructed to physically visit selected areas to collect information on selected features. The information gathered by field survey teams is the kind that the organizations mentioned in step 220 do not ordinarily have. For example, many of the attributes of a geographic database that enable route navigation and guidance can be gathered only by direct observation by a field survey team. Such attributes include turn restrictions, one-way streets, speed limits, and the unusual configuration of some intersections. In embodiments, these field survey crews drive the roads according to a predetermined schedule developed in step 140 in FIG. 1. The output of the field survey process is electronic and ready to use for map update. In step 270, the field survey information is placed into a library.

In step 270, all the source material information is collected by the various methods into a common library, for archiving and eventual staging for geographic database update. The source material information is in a mixture of electronic and hard forms, such as paper. For convenient access and management, the library is equipped with an electronic index with at least one entry for each instance of source material information and the capability of being searched with keywords and key source material information attributes including, but not limited to, date of acquisition, and organization providing it.

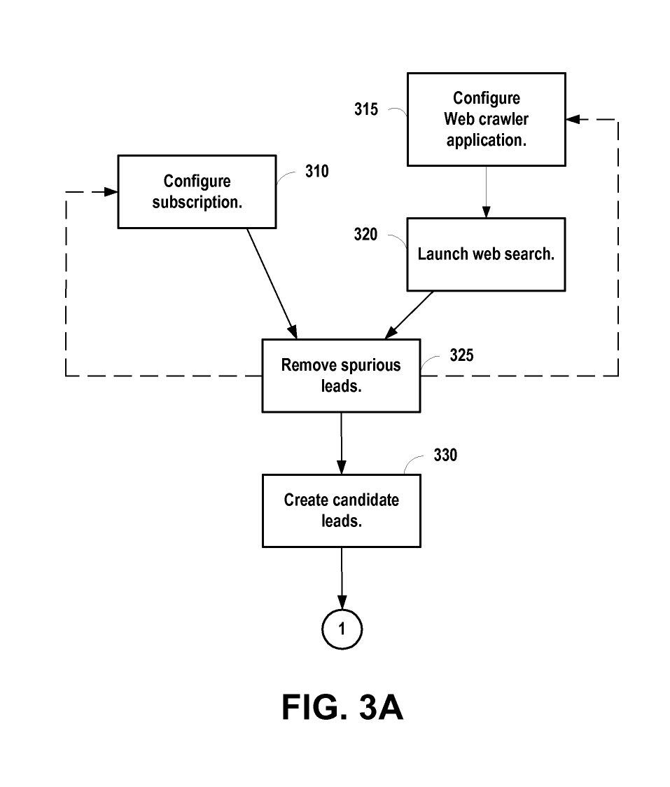

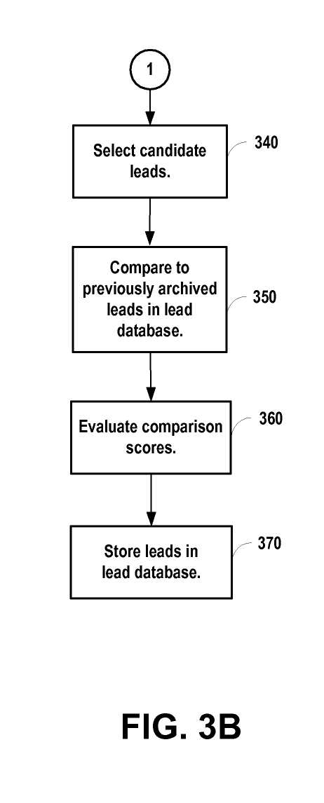

Because some source material information is infrequently updated and/or reported, and because visits by survey teams can be infrequent, it can take a long time, in some cases months, for a change to be detected by the source collection team. An example of such a change is a new one-way sign that needs to be incorporated into the master geographic database because the new sign may not be detected until several customers report it or a field survey team finds it. Moreover, it is difficult to know when and where significant changes to the real world are occurring so that source material information can be specifically collected or a survey team can collect this information. Consequently, there is a need for a method for data collectors to more quickly detect changes in the configuration of the roads, their attributes, or in the specification of driving constraints. Such a method is described below in relation to FIGS. 3A and 3B.

### Improved Change Detection

To improve the speed and completeness of change detection, a new method of collecting source material information is provided, according to embodiments. This new method can be added to the current methods described in the discussion related to step 220. By automating searches for changes in real-world geographic data, including the road configuration, road attributes, driving restrictions and other information that goes into the geographic database, the improved method speeds the detection of changes and increases the fraction of real-world changes detected. The search for changes in the real-world geographic data is made on the World Wide Web and results in universal resource locators (URLs) of Web pages that can indicate changes. A Web page that contains information on a change in the road network is called a “lead.” In embodiments, a lead is recorded as the URL of its primary Web page. In embodiments, the Web pages corresponding to the URL are recorded in order to keep the correct version of the Web pages, in case the Web pages are updated or removed from the Web. Leads worth pursuing further are submitted to the next step in collecting information for update, step 230 of FIG. 2.

In embodiments, the method searches for changes in geographic data feature types. These feature types include street network changes, street name changes, new addresses, changes in addresses, vehicle routing attributes, and navigation attributes among others. Vehicle routing attribute changes include, but are not limited to, changes to traffic flow patterns on the streets, such as lane structures, turn restrictions, and one-way streets, geometric street and address network changes, additions, and removals, as well as changes in point to point routes. Navigation attributes include, but are not limited to, speed limits, transit times, height and weight restrictions, axle restrictions, hours of operation and vehicle type restrictions.

Examples of changes to geographic data features include information related to changes by government and construction. Examples of changes by government include, but are not limited to, changes to government transportation networks, comprising permanent street closures, government annexations, government construction, geometric street network changes and traffic flow pattern changes, such as one way streets or prohibited turns. Changes in construction-related information include, but are not limited to, new commercial and residential subdivision construction information, comprising project status, wherein the project status is one of start, construct, and occupancy, size, cost, builder, as well as architect and general map information to further research project specifics and location. Changes to new residential subdivision construction related information includes, but is not limited to, related infrastructure and type of housing, where related infrastructure includes hospital and schools, and type of housing includes one of multi unit, single unit, model, and townhouse.

Example feature types include, but are not limited to, the following list of feature types:

Change in direction of vehicle traffic flow, for example, a street that was previously two-way is now one-way.

Change of vehicle turn restriction, for example, a previously allowable left, right, or U-turn is now prohibited.

New street signs and stoplights.

Removed street signs and stoplights.

Change of street name.

New street.

Permanent street closure.

New roundabout.

Newly paved roads, for example, roads that were previously dirt or gravel.

New gated or private communities.

New or renamed arenas or stadiums.

Airport construction or renaming.

Re-addressing, for example, change of address for one building, of all the addresses along a street, or of the addresses in an entire county.

New highway construction.

Municipal annexations.

### Gathering Phase

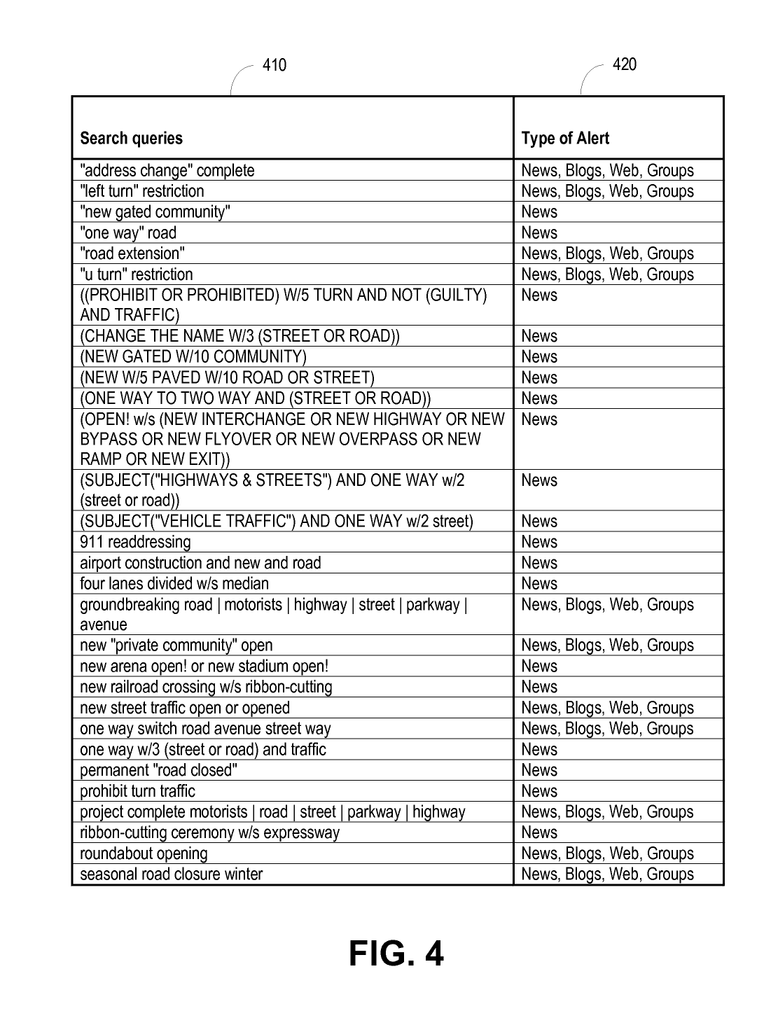

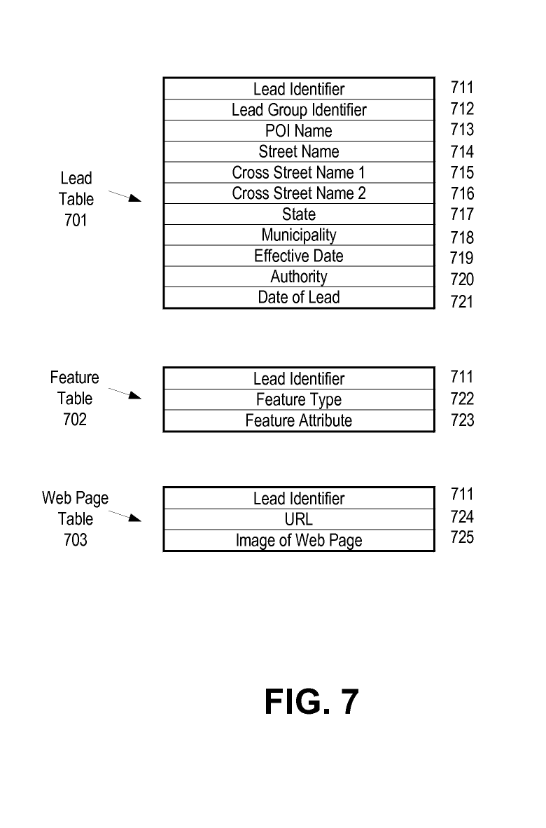

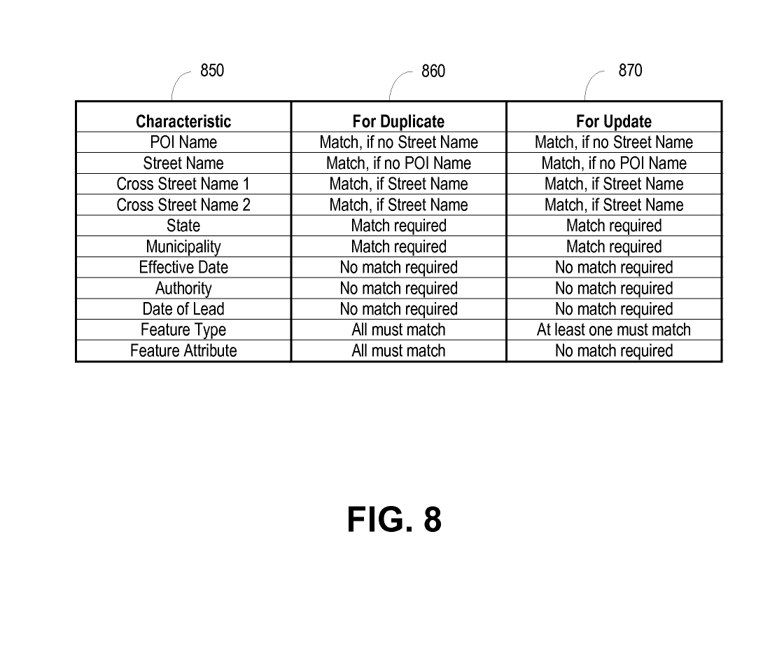

FIGS. 3A-3B show an example flowchart of an improved method for gathering source material information and managing overlaps, according to embodiments of the present invention. These two phases of this flowchart run in parallel with step 220 in FIG. 2. FIG. 3A shows an example flowchart for gathering source material information that potentially refer to changes in real-world geography. In a gathering phase, source material information is collected frequently and automatically, and the resulting sets of leads are formed into candidate leads. Later, in a managing overlaps phase, candidate leads that can refer to the same real-world change are identified and grouped together, as discussed in relation to FIG. 3B. FIG. 3A is discussed in conjunction with FIGS. 4-6. FIG. 3B is discussed in conjunction with FIGS. 7 and 8.

The gathering phase provides a method of gathering leads in a timely fashion. The method includes subscribing to information services, including existing or future information services that provide references to information on topics selected by the subscriber. Examples of these services include, but are not limited to, news and wire sources such as Google Alerts, Yahoo! Alerts, and LexisNexis Alerts. The present invention uses subscription services to find changes as they are happening along with automating part of the evaluation of the results of the services. The subscription services provide reports of the results by e-mail or by mail. The reported results can be URLs or paper documents. A soft copy of the reported results is the preferable format, for purposes of automating the geographic database update process.

In step 310, after subscribing to one of these subscription services, the service is configured. The configuration includes one or more logical query strings that are provided to the service. These queries are designed to specifically target and identify geographic features that have seen or will soon undergo changes. In embodiments, the source collection team provides these query strings. Each logical query string is a Boolean combination of keywords and phrases. Example keywords are “one-way” and its variants, “left turn,” “street name,” and “address.” In embodiments, the source collection team provides many logical query strings. An example query used to search for municipal ordinances that change one-way street assignments is “ordinance AND one-way.” Each logical query string is assigned a name for ease of reference.

FIG. 4 shows example query strings provided to example subscription services, according to embodiments of the present invention. A search queries column 410 provides a list of example query strings. A type of alert column 420 shows the type of source materials to investigate for matches to the corresponding query string. For example, if the type of alert is “News,” then the search looks only at news Web pages. As another example, if the type of alert is “Groups,” then the search looks only at groups such as Yahoo! Groups. The type of alert “Web” refers to searching the Web in general, not restricted to a certain subset.

Once the logical query strings are set up and the service initiated, the service periodically searches the World Wide Web based on the logical query strings supplied by the source collection team. In embodiments, the service sends search result reports to the source collection team via e-mail or mail. These e-mails or mail are sent according to a schedule specified by the subscriber and can be as often as the subscription service permits. This schedule can be as often as hourly, but a preferable schedule is daily. The use of these subscription services as a tool affords the opportunity to quickly identify instances and locations of change in geographic features in the real world.

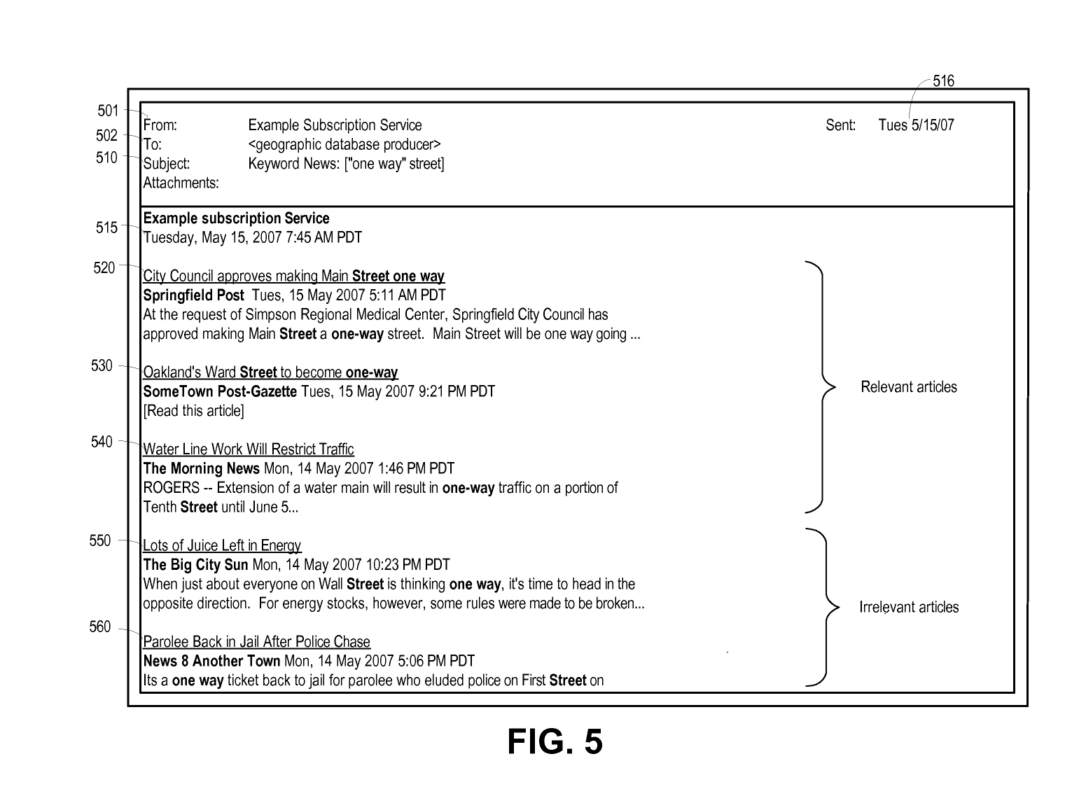

FIG. 5 shows an example report returned by an example subscription service, according to embodiments of the present invention. The content of this example report is fictional, and is used for illustrative purposes. This example report is in the form of an e-mail from the subscription service 501 to the geographic database producer 502. The query string provided to the service was “‘one way’ street” as shown in the subject line of the e-mail 510. The report was run on a date 515 of Tuesday May 15, 2007 and emailed on the same date 516. In this example, a news alert reports news articles found on the World Wide Web using in part the search criteria “‘one way’ street,” which is the same as “one way” AND “street.” The report is a list of links to Web pages that contain the content of articles. Accompanying each link is a summary of the Web page contents. For example, the first article in the report 520 is “City Council approves making Main Street one way” from the Springfield Post on May 15, 2007.

Alternatively, a subscription service can send an e-mail report that contains a link to a Web page that in turn contains similar information to that shown in FIG. 5. Some example of other information that a subscription service can send in a report are number of results found, the date the next report will be run, and the date the next report will be sent. Alert settings can also be shown in the report, such as the query string name, the search terms in the query string, and source materials searched on the World Wide Web.

In embodiments, software can automatically locate the query string in the Web pages returned in a subscription service report. Wherever the query string or partial query string are found in the Web pages, the query string or partial query string can be shown in bold or highlighted, for example, in order for the source collection team to find relevant Web pages more quickly. In FIG. 5, for example, the partial query strings of “one way” and “street” are shown in bold. In embodiments, an entire unit, such as a paragraph that contains the query string or partial query string can be shown in bold or highlighted. In embodiments, the query string or partial query string can be shown in any manner that makes them stand out from the rest of the Web page on which they are located.

For the report in FIG. 5, the source collection team determines whether links are relevant. Relevant links include those leading to content related to geographic features maintained in the geographic database. For example, in FIG. 5, links 520 and 530 are relevant because they indicate that streets will soon be changed to one-way streets. Links to irrelevant articles are ignored by the source collection team, for example, links 550 and 560. Link 550 is irrelevant because it is related to investing and not to geographic feature types, as the article contains advice for investors on Wall “Street” thinking “one way.” Link 560 is irrelevant because it is related to a police chase on First “Street” of a parolee who has a “one way” ticket back to jail. Link 560 is thus not to geographic feature types. Link 540 may be relevant because it discusses Tenth “Street” becoming temporarily “one way” due to water line work. The need for this link depends on the business plan of the geographic database producer and may require further analysis before deciding whether it is relevant. This further work would be done in steps 230 or 250. In certain high impact changes, attempts should be made to push them through the deficiency and update steps almost instantaneously.

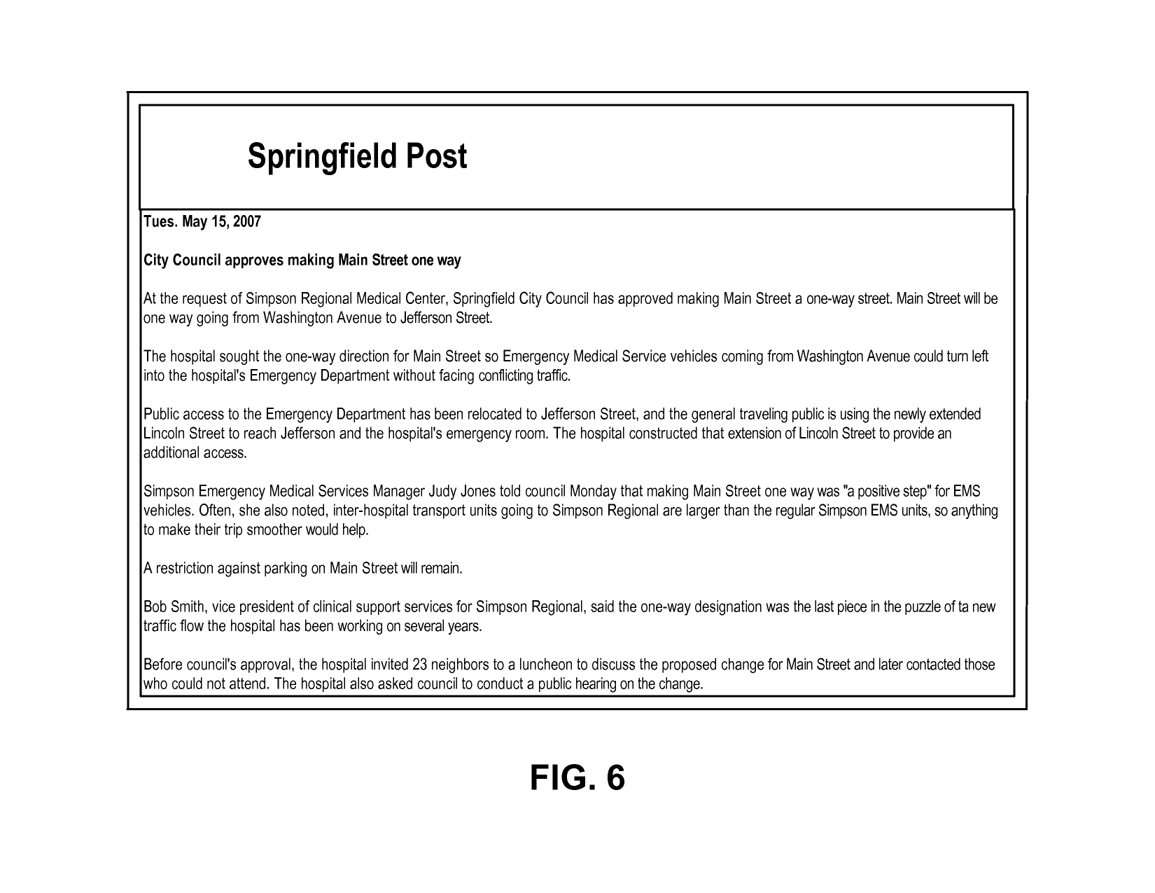

FIG. 6 shows an example Web page and corresponding example content referenced by the first item in the example report of FIG. 5, according to embodiments of the present invention. If the subscriber clicks on the first article hyperlink 520, the first Web page of the online article will be displayed to the subscriber, as shown in FIG. 6.

Another example query string that can be submitted to a subscription service is “street renaming.” Suppose an example link returned for this query string is “Street with no houses named after Abraham Lincoln.” Because a corresponding summary discusses “renaming” a “street” to Abraham Lincoln, this link is an example of a relevant lead. Suppose an example link returned for this query string is “Mixed Reaction to name extension.” Because a corresponding summary discusses town residents expressing mixed reactions to the extension of the “street renaming” public submission process, this link is an example of an irrelevant lead.

Another example query string that can be submitted to a subscription service is “groundbreaking road|motorists|highway|street|parkway|avenue”, where “|” is the logical “OR” sign, and the result must also include the term “groundbreaking.” An example link returned for this query string is “Jacksonville celebrates ‘groundbreaking’ for hospital.” This link is an example of a relevant lead, as a corresponding summary for the link discusses the “avenue” on which the hospital is located.

A Web page that corresponds to a link returned by the subscription service can have more than one lead. Suppose an example query string that is submitted to a subscription service is “prohibited turn” and “USA.” Suppose an example link returned for this query string is “Area traffic detours/delays” for a town. The Web page that corresponds to this link contains a list of traffic detours and delays, some of which might be relevant leads regarding “prohibited turns.” The page can also include other relevant leads that do not involve “prohibited turns.” As indicated by the search term “USA,” a search term can be used to limit the search to a particular geographic area.

In embodiments, a proprietary Web crawling application can be used for gathering leads. A Web crawling application is a search portal that searches other search engines for results. This program searches the World Wide Web for keywords and phrases that indicate the likelihood of relevant changes and according to other configuration choices discussed below. Relevant changes are those related to geographic features maintained in the geographic database. Example keywords include, but are not limited to, “one-way,” “left turn,” “street name,” and “address.” The program finds leads in places not generally covered by the subscription services.

In step 315 of FIG. 3A, a Web crawling application configuration is created and stored in a database management system for easy update and management. The configuration database is updated frequently through the configuration menu to remove unprofitable scanning instructions, add newly discovered conditions, and maintain alignment with the map update plans generated by step 120 in FIG. 1. The configuration database can contain limitations including, but not limited to, one or more of the following limitations on each search:

Keywords and/or phrases.

Limit on the number of pages to select from a domain group.

Limit on the number of sub-pages of a page to select.

A search can be configured to look in Web pages from a positive list including, but not limited to, one or more of the following:

Domain groups to search, for example, “.gov”

Specific Web pages to scan.

Specific Web sub-pages to scan.

A search can also be configured to look in Web pages except those in a list including, but not limited to, one or more of the following:

Domain groups to not search, for example, “.uk”

Specific Web pages not to scan.

Specific Web sub-pages not to scan.

In step 320, a selection is made of which parts of the configuration to use and a search is initiated. In embodiments, a member of the source collection team performs the search. The program automatically submits queries, using the keywords and phrases from the configuration database, to one of the available Web search engines. The results of these queries are automatically filtered according to the constraints on domains and pages stored in the configuration database. The remaining Web page URLs become leads. Lead gathering by the Web crawling application can be done as frequently as required to detect changes in a timely manner. The use of this program as a tool affords the opportunity to quickly identify instances and locations of change in geographic features in the real world.

In embodiments of the Web crawling application, the current version of a Web page is stored in order to some time later find changes that are relevant to digital map update. More specifically, the implementation software performs the following functions. The source collector identifies a set of stable Web pages, or the search set, that are known to report on changes relevant to updating the master geographic database. An example of a stable Web page is one from a more permanent website, such as a state Department of Transportation website that lists ongoing construction projects in the state. A newspaper article on a Web page is an example of a Web page that is not stable because it is ephemeral. For each page in the search set, its URL, a copy of the page, the date collected, and the topics for which it is relevant are stored. At some time later, each URL in the search set is visited, and the current Web page is stored with the stored Web page, looking for differences that are significant for updating the master geographic database. If differences are found, a report is issued that identifies the URL and an indication of the nature of the differences. An example of a difference that might be found on the state Department of Transportation website example above is the addition of a new construction project to the website. The application can be configured to run periodically so that the source collector receives reports automatically. The application contains a search set editor in order to add, change, or delete Web pages to the search set.

Whichever method of gathering leads is used, in embodiments, proprietary software can automatically parse the Web pages for the query string, where the Web pages were obtained through links returned from the search for the query string. Wherever the query string or partial query string are found in the Web pages, the query string or partial query string can be shown in bold or highlighted, for example, in order for the source collection team to find relevant Web pages more quickly. In embodiments, an entire unit, such as a paragraph that contains the query string or partial query string can be shown in bold or highlighted. In embodiments, the query string or partial query string can be shown in any manner that makes them stand out from the rest of the Web page on which they are located.

Designing specialized queries for geographic features using on-line tools such as the ones described here enables the change detection process to be much more targeted and offers a much faster rate of assimilation into the database than current methods of detecting change. These specialized queries and online search tools are part of a database feature compilation technique that can include field survey as well. The World Wide Web provides a clearinghouse of a vast amount of information. Although these tools must search through a lot of information, an advantage of the Web as a search tool and compilation technique, as used in the geographic data lead context, is that it is fast and inexpensive.

In step 325, with either method of gathering leads, the resulting set of leads must be filtered to remove spurious leads. Spurious leads are those leads not relevant to features maintained in the master geographic database. For example, a URL for a newspaper article about problems of lane markings in a United States Post Office parking lot will probably have no relevance to the street network, so it can be categorized as spurious. The quality of the configurations that produced the leads can be evaluated so that the source collector can provide suggestions for adjusting the configurations in steps 310 and 315 to produce fewer spurious leads.

Those leads surviving the spurious filter are formed into candidate leads in step 330. One lead can refer to only one real-world change event. Therefore, if a Web page describes several change events, then the source collector must generate one lead for each event. Two change events differ if they apply to different locations or to distinct sets of feature types at the same location. For example, one feature type is a “no left turn” sign with associated time or vehicle restrictions. A Web page that describes the introduction of two “no left turn” signs, one for each direction of traffic along a boulevard and both at the same intersection, generates one lead. Only one lead will be generated because the two signs are not of distinct feature types. This is the case even if the time restrictions are different, where an example time restriction is “7 a.m. to 7 p.m.” As another example, a Web page that describes a street name change and re-addressing on the same block generates two leads, one for the street name change, and one for the re-addressing, because these are of distinct feature types.

Further, in order to facilitate discovering whether two leads refer to the same real-world event, characteristics are assigned to each non-spurious lead. These characteristics include, but are not limited to, one or more of the following:

Location of the change as defined by:
Point of interest name.
Street or road name.
One or more cross street or bounding street names.
State, province, or country. For example, country in Europe.
Municipality or smallest subdivision, such as city, town, Census Designated Place, or county in the United States.

Feature types affected by the change.

Attributes of the affected feature types, such as position of road centerline, address ranges, and time constraints.

Date the change goes into effect, if available.

Authority for the change.

Date of the lead Web page or document.

Most of these characteristics can be assigned automatically by software, although some may be assigned manually by a source collector. One or the other of POI name or street name is a required characteristic, as are state, municipality, authority, and date of the lead. The remaining data items are optional, but desirable in order to unambiguously specify the change event.

Each candidate lead output in step 330 includes its URL, copies of its Web pages, and a record of its assigned characteristics.

### Managing Overlaps Phase

Candidate leads produced in FIG. 3A can overlap each other, referring to the same location and feature types. Two separate candidate leads are “duplicate” leads if they refer to exactly the same real-world event, meaning the same change to the same features at the same location. A candidate lead is an “update” lead if it refers to updated information on the same real-world event as a previously collected lead. A lead and its updates form a “lead group.”

For example, a candidate lead for a change from one-way to two-way traffic on Main Street was obtained from a newspaper report on a city council meeting, while another lead in the same set of current candidate leads was obtained from the minutes of the same city council meeting. These two leads will be duplicates because they will match on all relevant information. If six weeks later another newspaper report appears about the same one-way change but delays the effective date by six months, this new candidate lead is an update of the previous one.

FIG. 3B illustrates the flow of actions for detecting and managing overlapping candidate leads, according to embodiments of the present invention. The actions relate to a lead database, which includes all the leads previously collected by the geographic database producer. Recorded in the database for each lead are the characteristics of the lead, the Web pages describing the real-world change, and the relation of the lead to other leads. FIG. 3B continues from FIG. 3A, which together form an alternative method of gathering source material information to step 220 in FIG. 2. FIG. 3B is discussed in conjunction with FIGS. 7 and 8.

FIG. 7 shows an example set of lead tables, according to embodiments of the present invention. This set of normalized tables is one way to organize the characteristics of a lead in the lead database. A lead table 701 contains one record for each lead stored in the lead database. A lead identifier field 711, which is a required field, links the lead record to a feature table 702 and to a Web page table 703. For each record in the lead table 701, there must be at least one record in the feature table 702 and at least one record in the Web page table 703 corresponding to the record in the lead table by having identical values in their lead identifier fields 711. A lead group identifier field 712 specifies the lead group, if any, to which the lead belongs.

In the lead table 701, six fields identify the location of the event referred to by the lead. One or the other of the POI name field 713 or street name field 714 must contain data, and it is acceptable for both these fields to contain data. Neither cross street name field 715 nor 716 can contain data unless the street name field 714 contains data. The state field 717 and municipality field 718 must contain data. The lead table 701 also contains the effective date field 719, the authority field 720, and the date of lead field 721. The authority field 720 and date of lead field 721 must contain data.

The feature table 702 contains a feature type field 722 and a feature attribute field 723. The feature table 702 contains a record for each feature attribute of each feature type affected by the real world change represented by a lead in the lead table 701. For example, a feature type prohibited maneuver can have attributes “no left turn” and “except buses,” in which case the feature table will contain two records for the lead, one for each pair of feature type and attribute. The lead identifier field 711 and feature type field 722 are required to contain data in every record of the feature table 702.

The Web page table 703 contains a record for each Web page forming part of the candidate lead package. Each Web page is stored as an image in the image of Web page field 725 and, optionally, its URL is stored in a URL field 724. Lead identifier field 711 and image of Web page field 725 fields must contain data in every record of the Web page table 703.

In step 340, candidate leads are selected from the candidates created in step 330, and are selected for detecting overlaps with previously processed and archived leads in the lead database. The following steps show how one candidate lead is processed, but these steps are applied to all candidate leads created in step 330.

In step 350, the selected lead is compared to leads previously archived in the lead database. For the comparison, an index to the characteristics of the leads in the lead database is used in order to improve performance of the comparison. The first step in the comparison is to search the lead database for reasonably close matches to the values in the six location characteristics of the candidate lead selected in step 340. The leads in the lead database that match the candidate lead location data sufficiently closely are selected for closer analysis in step 360.

In an alternative embodiment, the comparison performed in step 350 uses the feature type field in addition to the six location fields for selecting leads from the lead database for further processing, because there must be some level of matching of feature type to identify a duplicate or update candidate lead.

Overlap detection and management is automatic but can occasionally require manual intervention for doubtful cases. A doubtful case can arise if one of the leads being compared does not have a complete set of characteristics, or if the matching of values is not definite enough for the software to unambiguously make a match or non-match.

FIG. 8 shows an example table of lead characteristics and requirements used to evaluate leads, according to embodiments of the present invention. For the comparison performed in step 350, a set of match scores is computed, one for each data item of the lead characteristics listed in the characteristic column 850 in FIG. 8 table. For each combination of candidate lead characteristic from lead table 701, in addition to pair of feature type and feature attribute from feature table 702, the candidate lead's characteristic is compared to all other leads' characteristics in the lead database. For each candidate lead combination, the other leads in the lead database are given a match score. Each match score results from comparing the value of a characteristic for the candidate lead with the corresponding value from a record in the lead database. For example, a match score for street name arises from comparing the street name string attached to a candidate lead with the value in the street name field of a lead in the lead database.

A number of methods are known for computing a score as a measure of how closely two values are matched. One such method defines a score to be a value between zero and one hundred, with zero meaning definitely not a match and one hundred meaning a perfect match. This discussion will assume that a scoring method has been selected that assigns zero to completely unmatched values and higher scores to closer matches. If the match scores for the candidate lead and each lead from the lead database is zero, then that candidate lead is eliminated from further consideration and is inserted into the lead database. If one or more of the match scores is non-zero, then that lead and its set of scores are kept with the candidate lead for further analysis. In embodiments, only a set of match scores containing a non-zero value is kept.

In step 360, the results of the comparison are evaluated for disposition of the candidate lead using the candidate lead and one or more leads from the lead database, the leads from the lead database each with its set of scores. In step 360, the candidate lead is classified as one of:

A lead describing a new real-world change event.

A duplicate of a lead from the lead database.

An update to a lead from the lead database.

If lead database leads do not accompany the candidate lead, then it is new and inserted directly into the lead database in step 370. The candidate lead is ready for use in updating the master geographic database.

If the candidate lead is accompanied by one or more lead database leads with their sets of scores, the scores are used to decide which classification applies. The classification proceeds in the following steps which use the requirements listed in the table in FIG. 8:

If the scores for the fields requiring a match for duplicates, as shown in the for duplicate column 860, in any set of scores are sufficiently high, then the candidate lead duplicates an existing lead and can be discarded. A sufficiently high score is one that exceeds a duplication threshold set in the configuration of the software. Duplication thresholds can be different for different characteristics.

If the scores for the fields requiring a match for updates, as shown in the for update column 870, in any set of scores are sufficiently high, then the candidate lead updates an existing lead. A sufficiently high score is one that exceeds an update threshold set in the configuration of the software. Update thresholds can be different for different characteristics and from corresponding duplication thresholds.

If the candidate lead updates an existing lead that belongs to a lead group, then the candidate lead is added to that lead group by attaching the lead group identifier 712 to it. The candidate lead is then inserted into the lead database in step 370.

If the candidate lead updates an existing lead that does not belong to a lead group, then the candidate lead and existing lead form a new lead group, and a new lead group identifier is inserted into both of their lead group identifier fields 712. The candidate lead is then inserted into the lead database in step 370, and the lead group identifier 712 field of the existing lead is updated with the new identifier value.

If the candidate lead is neither a duplicate nor an update, then it is new and inserted directly into the lead database in step 370. The candidate lead is ready for use in updating the master geographic database.

Any candidate leads that are ready for use in updating the master geographic database are then evaluated for deficiency in step 230 of FIG. 2, along with any other source material information gathered in step 220. The candidate leads are then processed along with the source material information through the execution of the processes of FIG. 2 and FIG. 1.

### System Hardware, Software, and Components

The present invention involves changes to a geographic database. Some vendors can utilize the geographic database or a derived compilation of that database. Other vendors, on the other hand, may use a geographic database-to-application converter to create a database for their device application software. Device application software accesses and manipulates the derived map data in response to user inputs. The software's output to the user can be in a list, text, graphical display such as a map or video, audio such as speech, or other type of output. Many GIS, Internet and Navigation applications can use the present invention. These applications include geocoding applications (text/list based), routing/directions applications (graphical/list/speech based) and graphical-based display applications. The applications can include navigation, Internet-based and Geographical Information Systems (GIS) among others. The application can be a mapping program, a navigation program, a GIS program, or some other type of program.

As discussed above, map application consumers have been provided with a variety of devices and systems to enable them to locate and travel to desired places. These devices and systems can be in the form of in-vehicle navigation systems containing a global positioning system (GPS), which enable a driver to navigate over streets and roads and to enter desired places. These devices and systems can also be in the form of portable hand-held devices such as personal digital assistants (“PDAs”) and cell phones that can do the same, as well as computers and laptops among others.

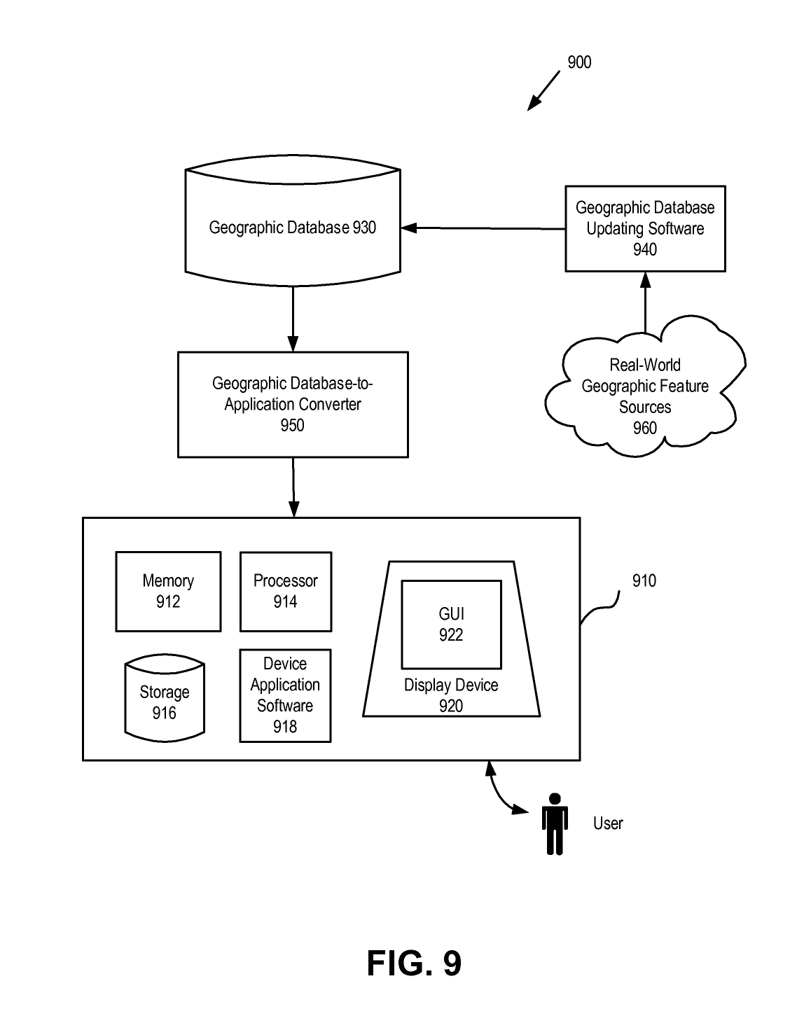

FIG. 9 shows a block diagram of an exemplary system 900 that can be used with embodiments of the invention. Although this diagram depicts components as logically separate, such depiction is merely for illustrative purposes. It will be apparent to those skilled in the art that the components portrayed in this figure can be combined or divided into separate software, firmware and/or hardware components. Furthermore, it will also be apparent to those skilled in the art that such components, regardless of how they are combined or divided, can execute on the same computing device/system or can be distributed among different computing devices/systems connected by one or more networks or other suitable communication means.

As shown in FIG. 9, the system 900 typically includes a computing device 910 which can comprise one or more memories 912, one or more processors 914, and one or more storage devices or repositories 916 of some sort. These processors, memories, and storage devices are used to execute the device application software 918 that accompanies the geographic database. The device 910 can further include a display device 920, including a graphical user interface or GUI 922 operating thereon by which the system can display maps and other information to a user. The user uses the computing device to request, for example, that a locality be displayed on a map or that driving directions be displayed as a route on a map and/or as text directions. A geographic database 930 is shown as external storage to computing device or system 910, but the geographic database 930 in some instances can be the same storage as storage 916. Proprietary geographic database update software 940 collects leads from real-world geographic feature sources 960. Software 940 includes any software for collecting information for update of the geographic database 930. Information from the geographic database 930 is used by a geographic database-to-application converter 950, which is ultimately used by a user of the computing device 910.

Embodiments of the present invention can include computer-based methods and systems which can be implemented using a conventional general purpose or a specialized digital computer(s) or microprocessor(s), programmed according to the teachings of the present disclosure. Appropriate software coding can readily be prepared by programmers based on the teachings of the present disclosure.

Embodiments of the present invention can include a computer readable medium, such as a computer readable storage medium. The computer readable storage medium can have stored instructions which can be used to program a computer to perform any of the features presented herein. The storage medium can include, but is not limited to, any type of disk including floppy disks, optical discs, DVDs, CD-ROMs, microdrives, and magneto-optical disks, ROMs, RAMs, EPROMs, EEPROMs, DRAMs, flash memory or any media or device suitable for storing instructions and/or data. The present invention can include software for controlling both the hardware of a computer, such as a general purpose/specialized computer(s) or microprocessor(s), and for enabling them to interact with a human user or other mechanism utilizing the results of the present invention. Such software can include, but is not limited to, device drivers, operating systems, execution environments/containers, user interfaces, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer-implemented method for transmitting the code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The foregoing description of embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. It is to be understood that other embodiments of the invention can be developed and fall within the spirit and scope of the invention and claims. The embodiments were chosen and described in order to best explain the principles of the invention and its practical application, thereby enabling others of ordinary skill in the relevant arts to understand the invention for various embodiments and with various modifications that are suited to the particular use contemplated. It is intended that the scope of the invention be defined by the following claims and their equivalents.

What is claimed is:

1. A computer-based method for the prompt collection of data related to changes in real-world geography for incorporation into a geographic database, the method comprising:
creating query strings that include keywords targeted to detect data related to changes in real-world geography;
utilizing automatic Web search technology to search the World Wide Web for instances that match the created query strings;
automatically collecting references to Web pages that potentially refer to changes in real-world geography as candidate leads; and
storing the candidate leads in a repository for use in updating the geographic database.

2. The computer-based method of claim 1, wherein utilizing the automatic Web search technology comprises subscribing to a subscription service.

3. The computer-based method of claim 2, wherein the subscription service comprises a World Wide Web news alert subscription service.

4. The computer-based method of claim 2, wherein subscribing to a subscription service comprises configuring the subscription services with a search schedule and with the created query strings to form a structured query.

5. The computer-based method of claim 4, wherein automatically collecting references to Web pages comprises periodically receiving the references from the subscription service after the subscription services uses the structured query to perform the search according to the search schedule.

6. The computer-based method of claim 1, wherein automatically utilizing the Web search technology comprises using a Web crawling application.

7. The computer-based method of claim 6, wherein using a Web crawling application comprises configuring the application with the created query strings to form a structured query.

8. The computer-based method of claim 7, wherein automatically collecting references to Web pages comprises receiving the references from the Web crawling application after the application uses the structured query to perform the search.

9. The computer-based method of claim 8, wherein using Web crawling application comprises including targeted domains and Web pages, and omitting selected domains and Web pages.

10. The computer-based method of claim 8, further comprising:
storing a stable Web page that corresponds to a received reference;
comparing the Web page to a newer version of the Web page after the Web crawling application uses the structured query to perform another search; and
receiving the reference to the Web page if a difference was found from the comparison.

11. The computer-based method of claim 1, further comprising filtering candidate leads.

12. The computer-based method of claim 11, wherein filtering candidate leads comprises eliminating those that are deficient, such that a deficient candidate lead is one that fails to comprise one or more of the following properties: relevancy, clarity, correctness, and legality.

13. The computer-based method of claim 12, wherein filtering candidate leads further comprises confirming deficient leads by one of an official publication of a government agency, a government official, an alternative information source, recent aerial photography, a field survey, and end users of the geographic database.

14. The computer-based method of claim 11, wherein filtering candidate leads comprises proceeding with those for which a change event has occurred and monitoring those for which a change event is scheduled for a future date.

15. The computer-based method of claim 11, wherein filtering candidate leads comprises eliminating spurious candidate leads, such that a spurious candidate lead includes a change event that applies to the same location as second candidate lead and includes a set of feature types that is indistinct from the second candidate lead feature type set.

16. The computer-based method of claim 11, wherein filtering candidate leads further comprises eliminating duplicate leads candidates.

17. The computer-based method of claim 16, wherein eliminating duplicate candidate leads comprises for one candidate lead:
comparing the candidate lead to leads stored in a lead database;
scoring each lead stored in the lead database based on the comparison; and
eliminating the candidate lead if the score is sufficiently high.

18. The computer-based method of claim 11, wherein filtering candidate leads further comprises managing candidate leads that update other candidate leads.

19. The computer-based method of claim 11, wherein managing candidate leads comprises for one candidate lead:
comparing the candidate lead to leads stored in a lead database;
scoring each lead stored in the lead database based on the comparison;
grouping the candidate lead with one or more leads in the lead database that have a sufficiently high score but not a score that identifies the candidate lead to be a duplicate lead.

20. The computer-based method of claim 1, wherein references to Web pages comprise references to Web pages accompanied by brief abstracts, Web pages, and hard copies of documents by mail.

21. The computer-based method of claim 1, further comprising updating the geographic database based on the information in the candidate leads.

22. The computer-based method of claim 1, further comprising periodically turning the geographic database into a product.

23. A system for the prompt collection of data related to changes in real-world geography for incorporation into a geographic database, the method comprising:
query strings that include keywords targeted to detect data related to changes in real-world geography;
automatic Web search technology utilized to search the World Wide Web for instances that match the created query strings;
references to Web pages that are automatically collected and that potentially refer changes in real-world geography as candidate leads; and
a repository that stores the candidate leads for use in updating the geographic database.

24. A machine-readable medium, including operations stored thereon that, when processed by one or more processors, causes a system to perform the steps of:
creating query strings that include keywords targeted to detect data related to changes in real-world geography;
utilizing automatic Web search technology to search the World Wide Web for instances that match the created query strings;
automatically collecting references to Web pages that potentially refer changes in real-world geography as candidate leads; and
storing the candidate leads in a repository for use in updating the geographic database.

25. A geographic database, storable on a storage medium, comprising:
updates to the geographic database based on candidate leads stored in a repository,
wherein the candidate leads are formed by a system that comprises:
query strings that include keywords targeted to detect data related to changes in real-world geography;
automatic Web search technology utilized to search the World Wide Web for instances that match the created query strings; and
references to Web pages that are automatically collected and that potentially refer to changes in real-world geography as candidate leads.

26. A portable hand-held device for providing a user with updated geographic database information, the device comprising:
a geographic database having updates based on candidate leads stored in a repository, wherein the candidate leads are formed by a system that comprises:
query strings that include keywords targeted to detect data related to changes in real-world geography;
automatic Web search technology utilized to search the World Wide Web for instances that match the created query strings; and
references to Web pages that are automatically collected and that potentially refer changes in real-world geography as candidate leads; and
an applications program for retrieving updates to the geographic database.

27. A Geographical Information Systems (GIS) based applications program for providing a user with updated geographic database information, the program comprising:
a geographic database having updates based on candidate leads stored in a repository, wherein the candidate leads are formed by a system that comprises:
query strings that include keywords targeted to detect data related to changes in real-world geography;
automatic Web search technology utilized to search the World Wide Web for instances that match the created query strings; and
references to Web pages that are automatically collected and that potentially refer changes in real-world geography as candidate leads.
